(19) United States
(12) Patent Application Publication
(10) Pub. No.: US 2013/0163407 A1
(43) Pub. Date: Jun. 27, 2013

(54) SYSTEM AND METHOD FOR DETERMINING NETWORK ELEMENT CRITICALITY

(71) Applicants: Koushik Sinha, Kolkata (IN); Arun V. Mahasenan, Bangalor (IN); Patrick S. Gonia, Maplewood, MN (US)

(72) Inventors: Koushik Sinha, Kolkata (IN); Arun V. Mahasenan, Bangalor (IN); Patrick S. Gonia, Maplewood, MN (US)

(73) Assignee: Honeywell International Inc., Morristown, NJ (US)

(21) Appl. No.: 13/333,474

(22) Filed: Dec. 21, 2011

(51) Int. Cl. H04W 40/02

(52) U.S. Cl. 370/217

(57) ABSTRACT

A method includes obtaining routing tables, and link quality to neighbor nodes for each node in a wireless multi-hop network, iteratively removing a network element and determining alternative routes for each such removed network element, and identifying critical network elements where inadequate alternative routes exist after network elements are removed. The method may be implemented by code stored on a computer readable storage device for execution by a computer in some embodiments.

### BACKGROUND

Building Controls have evolved from using wire-based communication to wireless communications for building management and control applications. This evolution started with wireless wall modules linking point-to-point to a variable air volume (VAV) controller. The next step involved migration to a VAV mesh based on lower power, low cost wireless devices as specified for example by a ZigBee® specification or the IEEE 802.15.4 communications standard. However, with the increase in the number of sensor nodes per building, need for supporting a richer set of building management functionalities and reducing cost as well as effort for deployment and maintenance, there is a need to develop a new wireless building management and control solution that can provide greater scalability and robustness in the face of failure and support higher data bandwidth.

Identification of articulation/pinch points in a given network graph has been studied for long in the context of network design. Various works in the literature have tried to solve the problem of articulation point identification through various methods—ranging from analyzing a graph connectivity/topology using graph theoretic algorithms to using statistical and stochastic methods for network/node reliability analysis. Most such methods in the literature present an application layer, network layer or MAC (media access control) layer only approach for determining network articulation points.

### SUMMARY

A method includes obtaining neighbors lists, routing tables, and link quality for each node in a wireless mesh network, iteratively removing a network element, such as a node or link, and determining alternative routes for each such removed node or link, and identifying critical nodes or links where inadequate alternative routes exist for removed nodes. The method may be implemented by code stored on a computer readable storage device for execution by a computer in some embodiments.

A computer system having computer executable code stored on a storage device to cause the computer system to execute a method, the method including evaluating for each node in a wireless mesh network whether the node is critical to adequate communications with other nodes in the mesh network, and assigning a node criticality value to each node as a function of the number of nodes having inadequate communications should the node fail.

### BRIEF DESCRIPTION OF THE DRAWINGS

FIG. 1 is a block diagram of a wireless network having a network diagnostic system according to an example embodiment.

FIG. 2 is a block diagram of a linear network topology with quantified node and link criticality values according to an example embodiment.

FIG. 3 is a block diagram of a network star topology with quantified node and link criticality values according to an example embodiment.

FIG. 4 is a block diagram of a wireless mesh network topology with quantified node and link criticality values according to an example embodiment.

FIG. 5 is a block diagram of a wireless mesh network topology with quantified node and link criticality values and color coding according to an example embodiment.

FIG. 6 is a flow diagram illustrating a method of calculating criticality in a wireless mesh network according to an example embodiment.

FIG. 7 is a flow diagram illustrating a high level method of determining critical nodes in a wireless mesh network according to an example embodiment.

FIG. 8 is a block diagram of an example computer system for implementing devices and methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

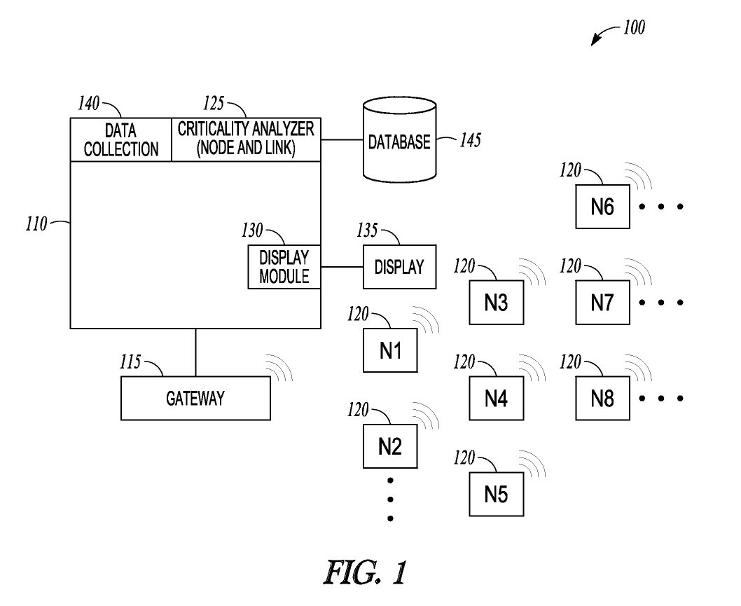

An IEEE 802.15.4 multi-hop network illustrated generally at 100 in FIG. 1 is used for building management applications. In one embodiment, a network diagnostic system 110 is coupled via a wire or wireless link to a gateway device 115, which is further wirelessly coupled to multiple wireless nodes 120, forming the multi-hop network. The diagnostic system 110 can quickly detect and pin-point wireless system problems such as node 120 failures when they occur. Wireless networks are typically very sensitive to the nature of the operating/radio-propagation medium. Given such dynamism in network properties, it is thus possible that the failure of certain nodes can adversely affect the application level Quality-of-Service (QoS) of one or more nodes 120 in the network. In other words, an application dependent on the network for its execution, may be adversely affected.

A critical node is a node whose potential failure can cause one or more other nodes in the network to fail to meet their application level QoS specifications for communications. Similarly, a link between nodes, usually a wireless link, is termed as a critical link if its failure or quality can cause one or more nodes in the network to fail to meet their application level QoS specifications for communications. The nodes and links may be thought of generically as network elements. For a given node (link), the notation NC (LC) is used to denote its node (link) criticality level. The diagnostic system 110 detects such potentially critical nodes and links early—either during installation itself or whenever a node becomes critical (due to network dynamisms). Such early warnings allow timely repair/tweaking of the network without system downtime.

In one embodiment, the diagnostic system 110 continuously or periodically monitors and detects critical nodes in such a wireless mesh network. The diagnostic system 110 monitors conditions such as connectivity, signal strength, and other parameters, as well as network and node changes including addition/deletion/relocation of nodes as they occur. The system may significantly reduce the deployment as well as maintenance cost and make wireless building management systems attractive to customers. A high speed wireless network with such a diagnostic system may be used in both current as well as future commercial buildings applications. Such applications include HVAC VAV control applications and configuring of the controllers, energy efficiency (smart grid related) applications, measurement and verification for energy efficiency, access control-security (excluding VideoIP using todays compression techniques) and lighting to name a few.

The diagnostic system 110 may reduce the deployment and maintenance time of the wireless mesh network, provide means to improve network connectivity and ability to meet application QoS requirements of throughput, reliability and latency, provide a mechanism to monitor the behavior of the network in a non-intrusive manner (i.e., transparent to the application) over a period of time and facilitating network real-time node-criticality analysis as well post mortem analysis.

In the face of network dynamisms, one embodiment includes a criticality analyzer 125 that implements a method for continuous monitoring and evaluation of the criticality levels of all nodes and links in a network and then presents a graphical, color-coded depiction of the evaluated criticality levels on a building map that shows the locations of the network nodes via a display routine 130 that may drive a display 135. In one embodiment, the criticality analyzer 125 implements a lightweight and application-traffic aware method with the ability to provide real-time feedback on network node criticalities. It is also generic enough to be easily adapted for any type of wireless network such as ZigBee®, 802.15.4 and ISA100.11a, among others. Furthermore, the method is capable of efficiently storing, retrieving and analyzing historical data collected over a period of time from the network via a data collection tool 140 and stored in a database 145 in order to provide various useful statistical data regarding the performance of the network.

In one embodiment, the network criticality diagnostic system (NCDS) includes four components:

1. A data collection tool (DCT) 140

2. A back-end database (DB) 145

3. A node and link criticality analyzer (NCA) 125

4. A display routine 130

The data collection tool 140 is responsible for collecting the neighborhood information of each node 120 in the network, including the gateway 115. The relevant information obtained from the network includes:

a. MAC (media access control) addresses of all neighboring nodes

b. Link quality measurements of links between all adjacent pairs of nodes and

c. Currently active routing table of each node

The data collection tool can be configured by the user to either collect the data from the mesh nodes and the gateway node periodically or for one-time diagnostics. Periodic data collection can be either initiated such as by SNMP (simple network management protocol) Get requests every time by the tool or the tool can configure the nodes to automatically send the data regularly in user-specified time intervals. The data collection may stop after a user specified number of iterations or after a user-specified time-out period occurs.

The data collected from the network nodes by the data collection tool 140 may be logged into a back-end database that resides on a building management network or other computing device coupled to the network. The node (link) criticality analyzer 125 reads the logged data from the database 145 and analyzes the criticality of the network nodes (links). The criticality analyzer 125 can be configured by the user either to run one-time or periodically. Furthermore, the criticality analyzer 125 can not only analyze the latest network information logged into the database 145 but can also analyze historic data to provide various useful statistics on the node (link) criticalities and consequently, network performance. The various uses cases that can be handled by diagnostic system 110 include display network topology augmented with node and link criticality levels between DATE-TIME T1 and DATE-TIME T2 with user specified time interval, display <selected> nodes in current network with criticality level=<value>, display <selected> nodes between DATE-TIME T1 and DATE-TIME T2 with criticality level=<value> with user specified time interval.

The output of the criticality analyzer 125 is directly fed to the display routine which then displays the network topology with the nodes (links) labeled with their respective node and link criticality (NC and LC) values and the node (link) colored with a color coding based on the respective NC-value (LC-value).

In one embodiment, the diagnostic system 110 may utilize the SNMP protocol for data collection, Microsoft SQL Server 2005 for DBMS based data logging and MATLAB based network data analyzer as well graphical display module for critical node analysis and graphical representation of the node criticalities on an appropriately annotated building map. In one embodiment, the diagnostic system 110 is used in an 802.11s mesh-based network, though it will work for any arbitrary network topology, as long as the data collection tool 140 for the intended network is able to log data in the appropriate formats into the appropriate tables of the database 145.

In one embodiment, the criticality analyzer 125 reads the historical data logged in the database 145 by the data collection tool 140 and analyzes the historical data based on network topology information, mesh management protocol and application QoS requirements for various useful instance-based as well as statistical information (e.g., average node and link criticality, percentage of time a node is at a given NC-level, reliability of a node expressed as a percentage of the time it is above a certain criticality level, etc.) regarding the performance of the network.

In a further embodiment, the criticality analyzer 125 reads the historical data logged in the database 145 by the data collection tool 140 and analyzes the historical data based on network topology information, mesh management protocol and application QoS requirements for various useful instance-based as well as statistical information (e.g., average link criticality, percentage of time a link is at a given LC-level, reliability of a link expressed as a percentage of the time it is above a certain criticality level, etc.) regarding the performance of the network.

A node (link) is referred to as critical, if its failure degrades the communications performance available to one or more nodes in the mesh network from an acceptable level to a non-acceptable level, i.e., below their specified communications QoS. In one embodiment, it is assumed that there is only one node failure at a time, the link and node qualities do not change during the execution of an instance of the critical node analysis routine, and node and link criticality of a given node ‘u’, NC(u)=number of nodes in the mesh whose performance will drop below a desired QoS due to failure of node ‘u’. A link criticality of a given link ‘k’, LC(k)=number of nodes in the mesh whose performance will drop below required QoS due to failure of link ‘u’.

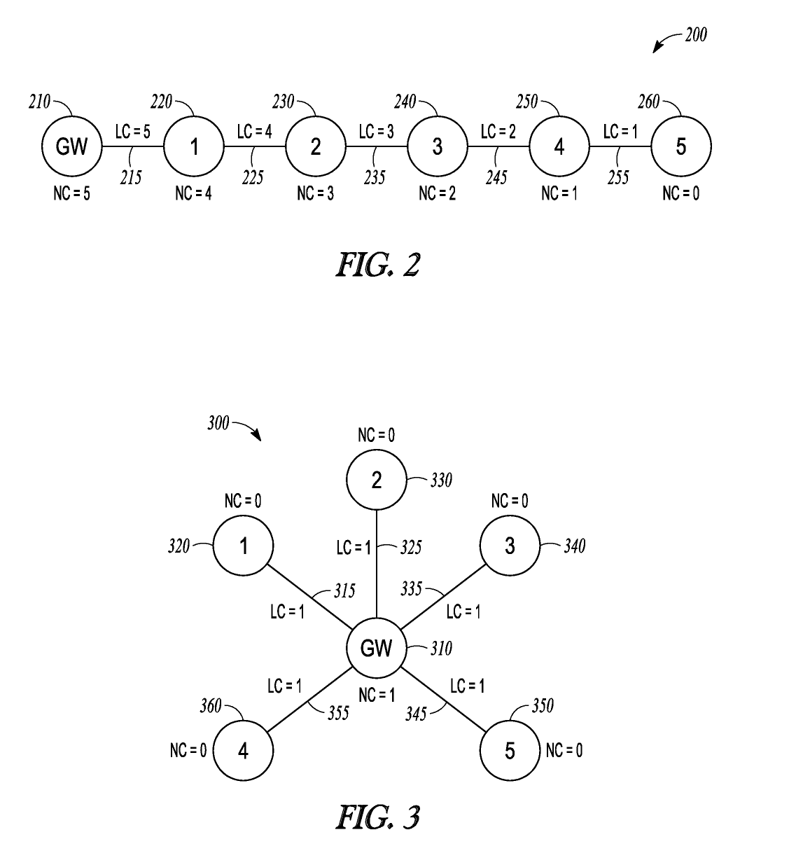

An example linear topology network 200 is illustrated in block form in FIG. 2. A gateway 210 is coupled via a link 215 to node 220, which is coupled in succession to link 225, node 230, link 235, node 240, link 245, node 250, line 255 and node 260, forming a string of nodes one through 5. Each node, including the gateway node 210 has an associated node criticality value. Gateway 210 has a node criticality shown as NC=5, because 5 nodes will have performance drop below a desired QoS if gateway 210 fails. Similarly, node 220 has NC=4, node 230 has NC=3, etc. Each link also has an associated link criticality, LC. Link 215 has an LC=5, Link 225 has LC=4, etc., calculated based on the number of nodes that will have performance drop below a desired QoS should the respective link fail.

FIG. 3 illustrates a star network node topology 300, where nodes 320, 330, 340, 350, and 360 are all coupled directly to gateway 310 via respective links 315, 325, 335, 345, and 355. Each node has NC=0, because no other nodes are affected should the node fail, while each link has LC=1, because exactly one node will drop in performance should a link fail.

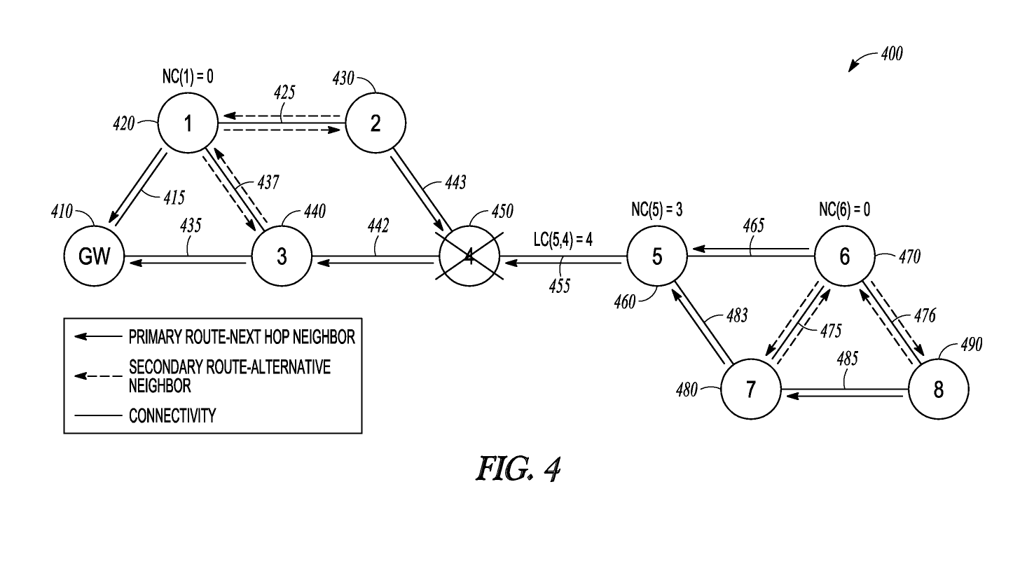

FIG. 4 illustrates a mesh network node topology 400 that includes a gateway 410 coupled via a link 415 to node 420. Node 420 is coupled via a link 425 to node 430. Gateway 410 is also coupled via a link 435 to a node 440 while is coupled via a link 437 to node 420. Node 440 is also coupled via link 442 to a node 450, which is also coupled via a link 443 to node 430. Node 450 is coupled via a link 445 to node 460. Note that link 455 is the only path that exists between node 450 and node 460. However, node 460 is coupled via a link 465 to node 470, which is coupled via links 475 and 476 to nodes 480 and 490 respectively. Nodes 480 and 490 are coupled to each other via a link 485. Node 460 is also coupled to node 480 via a link 483.

Each link may also be identified as a primary route by a solid line with arrow adjacent the link coupling the nodes or as a secondary route by a broken line adjunct the link. A primary route is a next hop neighbor. In other words, there are no other hops involved between the two nodes. Secondary routes indicate alternative neighbor connectivity. Nodes dependent on node 450 for a primary route includes the gateway 410, and nodes 430, 460, 470, 480, and 490. Any route to and from these dependent nodes to the gateway must pass through node 450 and link 455. The QoS demands of nodes 460, 470, 480, and 490 cannot be met if node 450 or link 455 is down. Thus, the node criticality of node 450 is either 4 or 5 depending on whether either the route from node 430 to node 420 to the gateway 410 can meet the QoS demands of nodes 420 and 430, or the route from node 430 to 420, to 440, to gateway 410 can meet the QoS demands of nodes 430, 420, and 440. Similarly the link quality of link 455 is LC=4 since the QoS demands of nodes 460, 470, 480, and 490 cannot be met if link 455 is down. This may also be expressed as LC(5,4)=4, where the “5,4” corresponds to the numbers in the nodes shown in FIG. 4.

The criticality information, may be used to determine where to place at least one additional node into the network to reduce the number of critical elements and thereby reduce the sensitivity of the network to failure and increase the reliability of the network. A user may for example, after placing the at least one additional node into the network determine by again calculating the criticality of the network elements that the network no longer contains any critical elements or at least contains fewer critical elements.

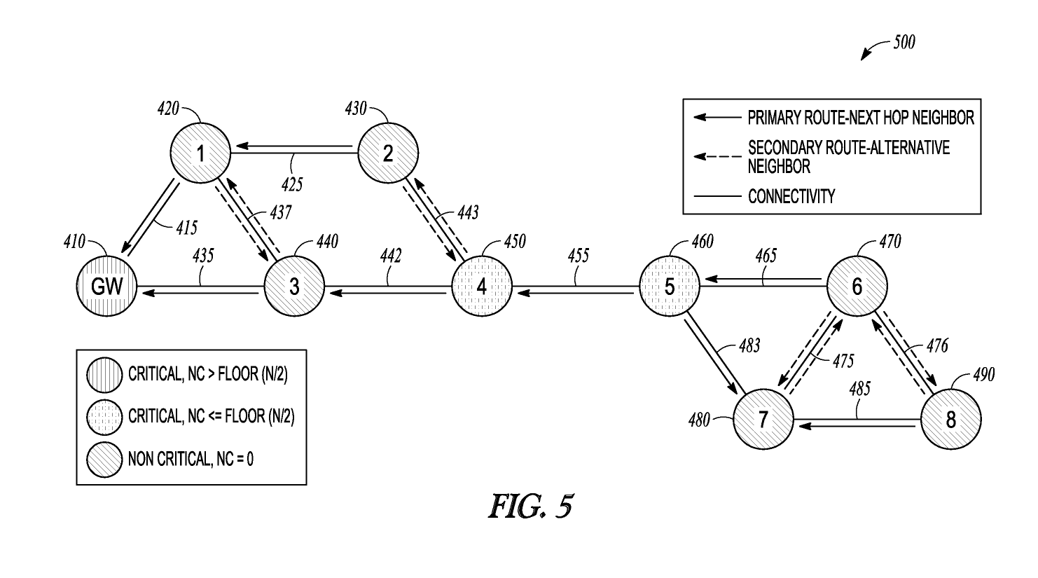

FIG. 5 illustrates color coding of the nodes illustrated in the mesh network of FIG. 4 generally at 500. The reference numbers in FIG. 5 are consistent with those of FIG. 4, with color added to illustrate a chart which may be displayed on display 135. In FIG. 5, one minor difference is that the routes between nodes 420, 430 and 450 may have different primary and secondary route identifiers.

Prior to analyzing input data (stored in the database 145) and generating the NC-values of the network nodes, a basic data structure may be built for the critical node/link analysis.

An n×n Adjacency matrix A=[aᵢⱼ], depicts a mesh network graph G=(V, E), where:

V=set of all nodes in the network, including the gateway node ‘g’

n=|V|, i.e., number of nodes in the network

E=set of all links in the network, derived from the neighbor list of each node.

An n×n Cost Matrix C=[cᵢⱼ], denotes the link quality of each link in the mesh network.

For a link (u, v), cᵤᵥ=Measured Airtime Link Metric value of link (u, v). Link metrics may be calculated according to the IEEE 802.11s standards documentation: A hybrid wireless mesh protocol (HWMP) is a routing protocol that periodically checks radio conditions with neighboring nodes to select routes. WLAN mesh network performance depends on the quality of the wireless links, interference and on the utilization of radio resources. An Airtime Link Metric (ATLM) has been designed to reflect all of these conditions. ATLM is used to determine the quality of each link within the mesh. It is the amount of channel resources consumed by transmitting the frame over a particular link.

The ATLM Cₐ for each link is calculated as:

$${c}_{a} = ( {O}_{ca} + {O}_{p} + \frac{{B}_{t}}{r} ) \frac{1}{1 - {e}_{pt}}$$

ATLM is encoded as an unsigned integer in units of 0.01 TU

O_{ca}=channel access overhead

Oₚ=protocol overhead

r=data rate in Mbps, at which the mesh STA would transmit a frame of standard size

eₚₜ=bit error rate for a test frame of size Bₜ bits

| Parameter | 802.11a | 802.11b | Description |
|---|---|---|---|
| O_{ca} | 75 μs | 335 μs | Channel access overhead |
| Oₚ | 110 μs | 364 μs | Protocol overhead |
| Bₜ | 8224 | 8224 | Number of bits in test frame |

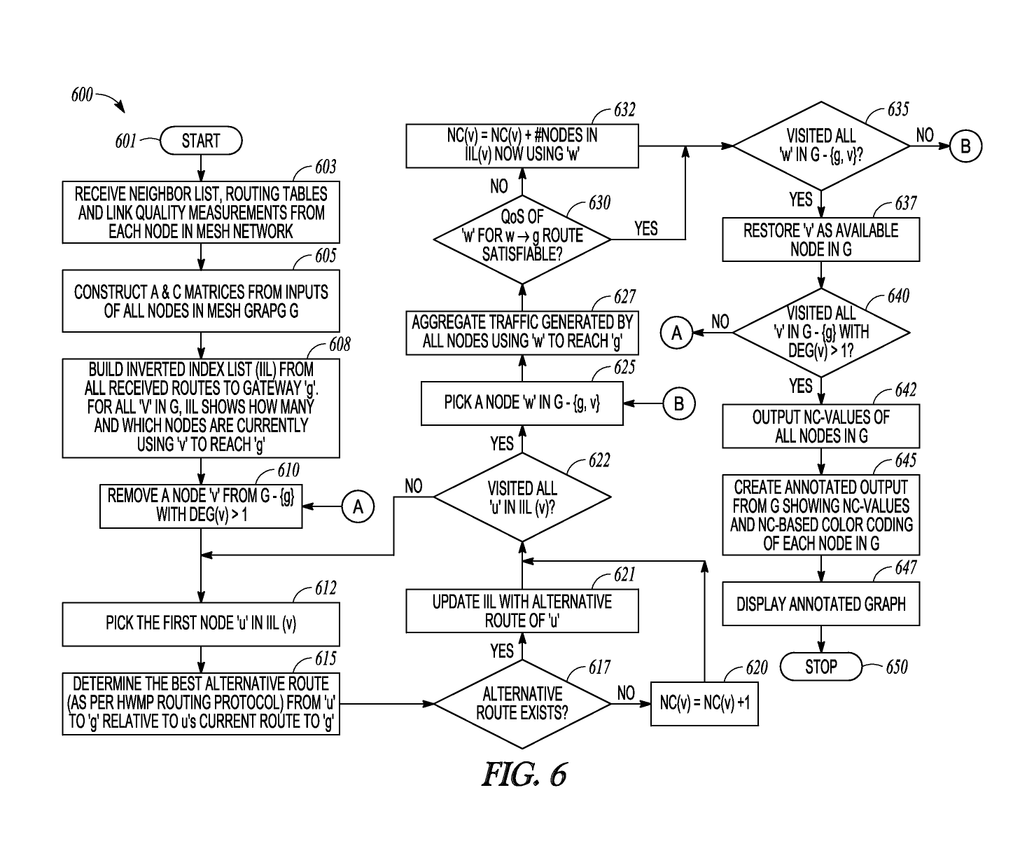

Once the quality of the links, as expressed as the ATLM is determined, the process of identifying critical nodes and links begins as shown in a method 600 in FIG. 6. The method 600 starts at 601 and receives neighbor lists, routing tables and link quality measurement from each node in the mesh network at 603. The adjacency and cost matrices from inputs of all the nodes in the mesh graph G are then constructed at 605.

At 608, an Inverted Index List (IIL) is created from the current routing tables of all ‘v’ in G—{g} showing how many and which nodes in G are dependent on ‘v’ for reaching ‘g’. At 610, a single node ‘v’ with node degree, deg(v)>1 is removed from G. At 612, the first node ‘u’ in IIL(v) is picked. The best alternative path/route from ‘u’ to the gateway node ‘g’ relative to the current route from ‘u’ to ‘g’ is then determined at 615.

In one embodiment, the HWMP mesh routing protocol may be simulated to determine the best alternative paths. Other routing protocol methods may be used to select a path. If no such path exists for ‘u’ as determined at 617, then add 1 to criticality of ‘v’ for node ‘u’ at 620.

At 621, the IIL is updated using the current and the alternative route paths to ‘g’ for all u in IIL(v) obtained from 615 until all ‘u’ in ILL(v) are visited as determined at 622. From the updated 11L, for each node ‘w’ in G—{g, v} at 625, aggregate the traffic generated by all nodes using ‘w’ to reach ‘g’ at 627, and use the current latency-traffic data to determine from the routing table of ‘w’ if the latency/throughput QoS demand for the net traffic from ‘w’ along the route w→g can be satisfied at 630.

If not, the criticality of node ‘v’ is increased by the number of nodes in IIL(v) that are now using ‘w’ to reach ‘g’ at 632. At 635, ‘v’ is restored as an available node at 637 and repeat from 610 for all ‘v’ in G—{g} as determined at 640.

At 642, the NC values of each node in the mesh network G are output. At 645, an annotated output graph from G may be created showing NC-values and NC-based color coding of each node in G. At 647, the annotated graph may be displayed and used to modify the network to minimize exposure of the application to critical nodes. The method 600 ends at 650.

The algorithm involved in analyzing input data (stored in the DB) and generating the LC-values of the network links by the criticality analyzer 125 is now outlined:

Step 1: Read from the database the recent-most routing and neighbor lists of each node ‘v’ in the mesh network ‘G’ obtained by the DCT 140. Construct an adjacency/cost matrix denoting the connectivity and link quality of each link in the mesh network. A lack of connectivity between two nodes is depicted by an appropriate notation choice of infinity (e.g., 2³²−1 for the HWMP routing protocol as used by IEEE 802.11s).

Step 2: Create an Inverted Index List (IIL) from the adjacency/cost matrix constructed in step 1 for all links ‘1’ in G showing how many and which nodes in G are dependent on ‘1’ for reaching ‘g’, where ‘g’ represents the gateway node.

Step 3: Remove a single link ‘1’ connecting two nodes—both with node degree>1—from G and do the following:

Step 3.1: For each node ‘u’ in IIL(1), determine the best alternative path/route from ‘u’ to the gateway node ‘g’ relative to the current route from ‘u’ to ‘g’. Simulate the mesh routing protocol used by the mesh network to determine a path with the available links. If no such path exists for ‘u’, then add 1 to criticality of ‘1’ for node ‘u’

Step 3.2: Update the IIL using the current and the alternative route paths to ‘g’ for all u in IIL(1) obtained from Step 3.1.

Step 3.3: From the updated IIL, for each node ‘w’ in G, aggregate the traffic generated by all nodes using link ‘1’ to reach ‘g’ and use a latency-traffic model (can be a plug-in developed independent of the system described in step 1 above) to determine from the routing table of ‘w’ if the latency/throughput QoS demand for the net traffic from ‘w’ along the route w to g can be satisfied.

If not, then add to the criticality of link ‘1’ the number of nodes in IIL(1) that are now using ‘w’ to reach ‘g’.

Step 4: Restore ‘1’ as an available link and repeat from Step 3 for all ‘1’ in G.

Step 5: Output the LC values of each link in the mesh network G. Create annotated an output graph from G showing the LC-values and the LC-based color coding of each link in G.

Several example embodiments are now presented.

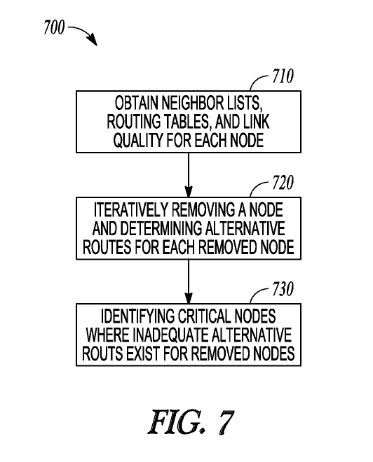

In one example method illustrated at 700 in FIG. 7 includes obtaining neighbor lists, routing tables, and link quality for each node in a wireless mesh network at 710, iteratively removing a node and determining alternative routes for each such removed node at 720, identifying critical nodes where inadequate alternative routes exist for removed nodes at 730.

1. A method comprising:

obtaining routing tables, and link quality to neighbor nodes for each node in a wireless multi-hop network;

iteratively removing a network element and determining alternative routes for each such removed network element; and

identifying critical network elements where inadequate alternative routes exist after network elements are removed.

2. The method of example 1 wherein inadequate alternative routes are determined based on the ability of the network to provide service required by an application.

3. The method of example 1 and further comprising creating an annotated graph of the nodes that identifies at least one critical network elements.

4. The method of example 1 and further comprising determining a quality of service for each alternative route.

5. The method of example 4 wherein an alternative route is inadequate if the quality of service is below threshold required for at least one application being served by the network.

6. The method of example 1 and further comprising building a list of nodes dependent on a removed network element to reach another node or gateway.

7. The method of example 1 and further comprising assigning a criticality value to each node removed during the iteration as a function of the number of nodes left in the network that lack adequate alternative routes.

8. The method of example 1 wherein a node is identified as critical if its failure adversely affects communications of at least one other node in the network below an acceptable quality of service level.

9. The method of example 1 wherein a link between a pair of nodes is identified as critical if its failure adversely affects communications of at least one other node in the network below an acceptable quality of service level.

10. A computer system having computer executable code stored on a storage device to cause the computer system to execute a method, the method comprising:

evaluating for each network element in a wireless multi-hop network whether the network element is critical to adequate communications required by other network elements in the network; and

assigning a network element criticality value to each network element as a function of the number of nodes having inadequate communications should the network element fail.

11. The computer system of example 10 wherein the computer system evaluates criticality of nodes by:

obtaining routing tables, and link quality to neighbors for each node in the wireless multi-hop network;

iteratively removing a network element and determining alternative routes for each such removed network element; and

identifying critical network element where inadequate alternative routes exist for removed network elements.

12. The computer system of example 11 wherein inadequate alternative routes are determined based on the ability of the network to provide the service required by an application.

13. The computer system of example 11, wherein the method further comprises:

determining a quality of service for each alternative route, wherein an alternative route is inadequate if the quality of service is below a threshold quality of service of an application being served by the network;

assigning a criticality value to each network element removed during the iteration as a function of the number of nodes left in the network that lack adequate alternative routes; and

wherein a node is identified as critical if its failure adversely affects communications of at least one other node in the network below an acceptable quality of service level and wherein a link between a pair of nodes is identified as critical if its failure adversely affects communications of at least one other node in the network below an acceptable quality of service level.

14. A computer readable storage device having instructions stored thereon to cause a computer to execute a method, the method comprising:

obtaining routing tables, and link quality to neighbor nodes for each node in a wireless multi-hop network;

iteratively removing a network element and determining alternative routes for each such removed network element; and

identifying critical network elements where inadequate alternative routes exist after network elements are removed.

15. The computer readable storage device of example 14 wherein inadequate alternative routes are determined based on the ability of the network to provide service required by an application.

16. The computer readable storage device of example 14 wherein the method further comprises creating an annotated graph of the nodes that identifies at least one network element.

17. The computer readable storage device of example 14 wherein the method further comprises determining a quality of service for each alternative route, wherein an alternative route is inadequate if the quality of service is below a threshold required for at least one application being served by the network.

18. The computer readable storage device of example 14 wherein the method further comprises assigning a criticality value to each node removed during the iteration as a function of the number of nodes left in the network that lack adequate alternative routes.

19. The computer readable storage device of example 14 wherein a node is identified as critical if its failure adversely affects communications of at least one other node in the network below an acceptable quality of service level and wherein a link between a pair of nodes is identified as critical if its failure adversely affects communications of at least one other node in the network below an acceptable quality of service level.

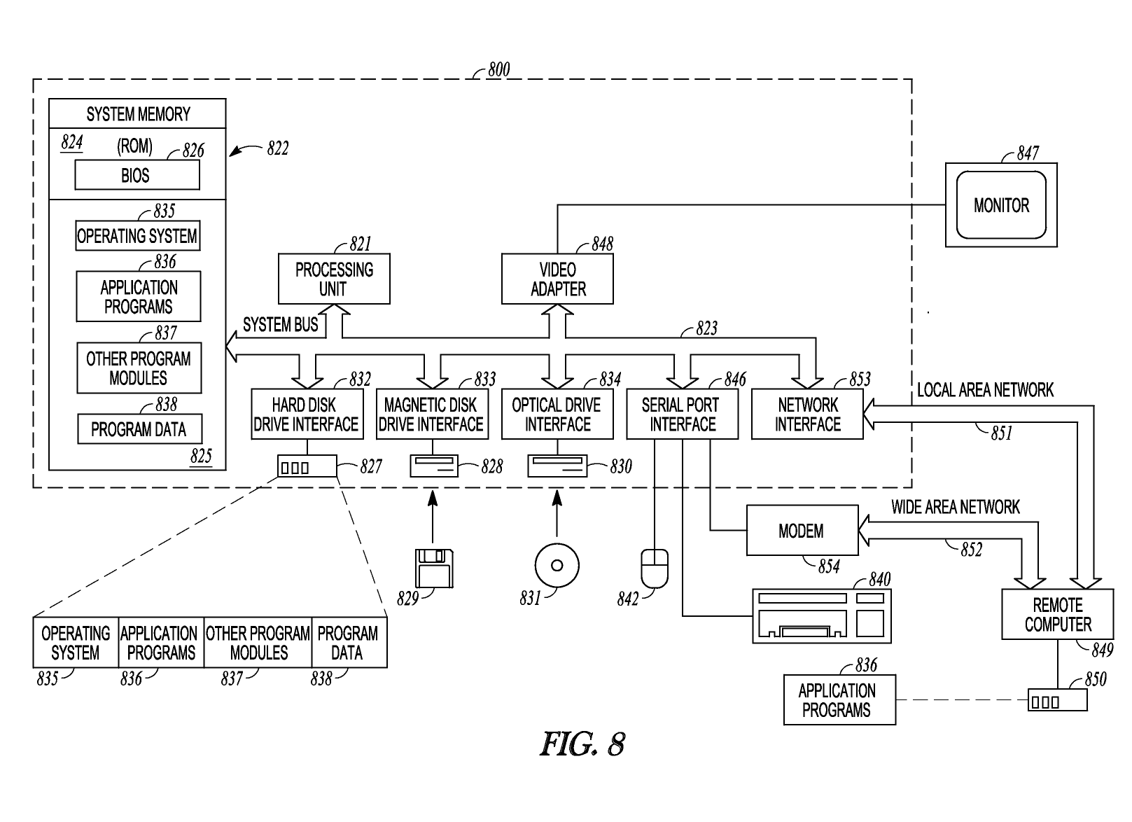

FIG. 8 is a block diagram of a computer system to implement methods according to an example embodiment. In the embodiment shown in FIG. 8, a hardware and operating environment is provided that is applicable to any of the diagnostic system 110, gateways, and nodes shown in the other Figures. The computer system has additional components shown that may not be need to accomplish the functions of many of the devices it can be used to implement, and such components may be removed as desired.

As shown in FIG. 8, one embodiment of the hardware and operating environment includes a general purpose computing device in the form of a computer 800 (e.g., a personal computer, workstation, or server), including one or more processing units 821, a system memory 822, and a system bus 823 that operatively couples various system components including the system memory 822 to the processing unit 821. There may be only one or there may be more than one processing unit 821, such that the processor of computer 800 comprises a single central-processing unit (CPU), or a plurality of processing units, commonly referred to as a multiprocessor or parallel-processor environment. In various embodiments, computer 800 is a conventional computer, a distributed computer, or any other type of computer.

The system bus 823 can be any of several types of bus structures including a memory bus or memory controller, a peripheral bus, and a local bus using any of a variety of bus architectures. The system memory can also be referred to as simply the memory, and, in some embodiments, includes read-only memory (ROM) 824 and random-access memory (RAM) 825. A basic input/output system (BIOS) program 826, containing the basic routines that help to transfer information between elements within the computer 800, such as during start-up, may be stored in ROM 824. The computer 800 further includes a hard disk drive 827 for reading from and writing to a hard disk, not shown, a magnetic disk drive 828 for reading from or writing to a removable magnetic disk 829, and an optical disk drive 830 for reading from or writing to a removable optical disk 831 such as a CD ROM or other optical media.

The hard disk drive 827, magnetic disk drive 828, and optical disk drive 830 couple with a hard disk drive interface 832, a magnetic disk drive interface 833, and an optical disk drive interface 834, respectively. The drives and their associated computer-readable media provide non volatile storage of computer-readable instructions, data structures, program modules and other data for the computer 800. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 829, optical disk 831, ROM 824, or RAM 825, including an operating system 835, one or more application programs 836, other program modules 837, and program data 838. Programming for implementing one or more processes or method described herein may be resident on any one or number of these computer-readable media.

A user may enter commands and information into computer 800 through input devices such as a keyboard 840 and pointing device 842. Other input devices (not shown) can include a microphone, joystick, game pad, satellite dish, scanner, or the like. These other input devices are often connected to the processing unit 821 through a serial port interface 846 that is coupled to the system bus 823, but can be connected by other interfaces, such as a parallel port, game port, or a universal serial bus (USB). A monitor 847 or other type of display device can also be connected to the system bus 823 via an interface, such as a video adapter 848. The monitor 847 can display a graphical user interface for the user. In addition to the monitor 847, computers typically include other peripheral output devices (not shown), such as speakers and printers.

The computer 800 may operate in a networked environment using logical connections to one or more remote computers or servers, such as remote computer 849. These logical connections are achieved by a communication device coupled to or a part of the computer 800; the invention is not limited to a particular type of communications device. The remote computer 849 can be another computer, a server, a router, a network PC, a client, a peer device or other common network node, and typically includes many or all of the elements described above I/O relative to the computer 800, although only a memory storage device 850 has been illustrated. The logical connections depicted in FIG. 8 include a local area network (LAN) 851 and/or a wide area network (WAN) 852. Such networking environments are commonplace in office networks, enterprise-wide computer networks, intranets and the internet, which are all types of networks.

When used in a LAN-networking environment, the computer 800 is connected to the LAN 851 through a network interface or adapter 853, which is one type of communications device. In some embodiments, when used in a WAN-networking environment, the computer 800 typically includes a modem 854 (another type of communications device) or any other type of communications device, e.g., a wireless transceiver, for establishing communications over the wide-area network 852, such as the internet. The modem 854, which may be internal or external, is connected to the system bus 823 via the serial port interface 846. In a networked environment, program modules depicted relative to the computer 800 can be stored in the remote memory storage device 850 of remote computer, or server 849. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
obtaining link quality to neighbor nodes for each node in a wireless multi-hop network;
iteratively removing a network element and determining alternative routes for each such removed network element; and
identifying critical network elements where inadequate alternative routes exist after network elements are removed.

2. The method of claim 1 wherein inadequate alternative routes are determined based on the ability of the network to provide service required by an application.

3. The method of claim 1 and further comprising creating an annotated graph of the nodes that identifies at least one critical network element.

4. The method of claim 1 and further comprising determining a quality of service for each alternative route.

5. The method of claim 4 wherein an alternative route is inadequate if the quality of service is below threshold required for at least one application being served by the network.

6. The method of claim 1 and further comprising building a list of nodes dependent on a removed network element to reach another node or gateway.

7. The method of claim 1 and further comprising assigning a criticality value to each node removed during the iteration as a function of the number of nodes left in the network that lack adequate alternative routes.

8. The method of claim 1 wherein a node is identified as critical if its failure adversely affects communications of at least one other node in the network below an acceptable quality of service level.

9. The method of claim 1 wherein a link between a pair of nodes is identified as critical if its failure adversely affects communications of at least one other node in the network below an acceptable quality of service level.

10. A computer system having computer executable code stored on a storage device to cause the computer system to execute a method, the method comprising:
evaluating for each network element in a wireless multi-hop network whether the network element is critical to adequate communications required by one or more nodes in the network; and
assigning a network element criticality value to each network element as a function of the number of nodes having inadequate communications should the network element fail.

11. The computer system of claim 10 wherein the computer system evaluates criticality of network elements by:
obtaining link quality to neighbors for each node in the wireless multi-hop network;
iteratively removing a network element and determining alternative routes for each such removed network element; and
identifying critical network elements where inadequate alternative routes exist after network elements are removed.

12. The computer system of claim 11 wherein inadequate alternative routes are determined based on the ability of the network to provide the service required by an application.

13. The computer system of claim 11, wherein the method further comprises:
determining a quality of service for each alternative route, wherein an alternative route is inadequate if the quality of service is below a threshold quality of service of an application being served by the network;
wherein a node is identified as critical if its failure adversely affects communications of at least one other node in the network below an acceptable quality of service level and wherein a link between a pair of nodes is identified as critical if its failure adversely affects communications of at least one other node in the network below an acceptable quality of service level.

14. A computer readable storage device having instructions stored thereon to cause a computer to execute a method, the method comprising:
obtaining link quality to neighbor nodes for each node in a wireless multi-hop network;
iteratively removing a network element and determining alternative routes for each such removed network element; and
identifying critical network elements where inadequate alternative routes exist after network elements are removed.

15. The computer readable storage device of claim 14 wherein inadequate alternative routes are determined based on the ability of the network to provide service required by an application.

16. The computer readable storage device of claim 14 wherein the method further comprises creating an annotated graph of the nodes that identifies at least one network element.

17. The computer readable storage device of claim 14 wherein the method further comprises determining a quality of service for each alternative route, wherein an alternative route is inadequate if the quality of service is below a threshold required for at least one application being served by the network.

18. The computer readable storage device of claim 14 wherein the method further comprises assigning a criticality value to each node removed during the iteration as a function of the number of nodes left in the network that lack adequate alternative routes.

19. The computer readable storage device of claim 14 wherein a node is identified as critical if its failure adversely affects communications of at least one other node in the network below an acceptable quality of service level and wherein a link between a pair of nodes is identified as critical if its failure adversely affects communications of at least one other node in the network below an acceptable quality of service level.

20. The computer readable storage device of claim 14 wherein at least one node is added to the wireless multi-hop network based on the identified critical network elements to reduce the number of identified critical elements.
